(19) United States
(12) Patent Application Publication
(10) Pub. No.: US 2005/0095490 A1
(43) Pub. Date: May 5, 2005

(54) Fuel cell assembly gasket for fuel containment

(76) Inventors: Laurie S. Mittelstadt, Palo Alto, CA (US); Yoocharn Jeon, Palo Alto, CA (US); Alfred Pan, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/697,687

(22) Filed: Oct. 31, 2003

(51) Int. Cl. H01M 2/08; H01M 8/10; H01M 8/02

(52) U.S. Cl. 429/35; 429/30; 429/36

(57) ABSTRACT

A fuel cell assembly includes a membrane electrode assembly having a substantially solid polymer electrolyte membrane positioned between opposed catalyst layers. The polymer electrolyte membrane has a dimension that is relatively larger than a comparable dimension of at least one of the catalyst layers, such that the polymer electrolyte membrane has an uncovered portion. The fuel cell assembly also includes a gasket attached to the uncovered portion of the polymer electrolyte membrane. The gasket extends beyond a periphery of the polymer electrolyte membrane and the gasket is formed of a polymer material. In addition, the gasket is configured to substantially seal the edges of the polymer electrolyte membrane to substantially prevent leakage of fuel or oxidant between an anode side and a cathode side of the membrane electrode assembly.

### BACKGROUND OF THE INVENTION

Proton exchange membrane, or polymer electrolyte membrane, (PEM) fuel cells employ a relatively simple chemical process to combine hydrogen and oxygen into water and produces electric current in the process. The general principles of construction and operation of PEM fuel cells are so well known that they need not be discussed in great detail.

In general, in PEM fuel cells, a fuel with an oxidant is converted to electric energy in the presence of a catalyst. The fuel is supplied to an anode and the oxidant is supplied to a cathode. The two electrodes are connected within the fuel cell by an electrolyte to transmit protons from the anode to the cathode. The supply of fuel and oxidant is distributed as uniformly as possible over the active surfaces of the respective electrodes, or, more specifically, the electrode surfaces facing the PEM, each of which typically includes a catalyst layer thereon. An electrochemical reaction takes place at and in between the anode and the cathode, with attendant formation of a product of the reaction between the fuel and oxidant, release of thermal energy, creation of an electrical potential difference between the electrodes, and travel of electric charge carriers between the electrodes, to thus generate electric energy.

A concern with PEM fuel cells is reactant distribution and containment within the cell. It is necessary to ensure that neither any liquid, such as fuel, product, or coolant water in a PEM fuel cell, nor any gaseous media such as the fuel or oxidant, be able to flow in or out of the periphery or edge of the respective porous fuel transport plate or electrode substrate. The escape of fuel through the periphery or edge of the water transport plates or electrode substrates typically results in the loss of the respective media, thereby causing a decrease in the fuel cell efficiency. Preventing the escape of media through the periphery or edge of the water transport plate or electrode substrate is thus critical to avoid the mixture of fuel with the oxidant gas or liquid or ambient air.

One attempt to maintain separation between the fuel and oxidant has been through use of relatively rigid, heavy flow field plates. These plates are typically made from graphite, resin-impregnated graphite, stainless steel, or titanium. In addition, gaskets made from Viton, Santoprene, Styrene-bytadiene copolymers, rubber or silicone are oftentimes positioned between the plates and bolted together. The plates and the gaskets are often bolted tightly together in an effort to create an impermeable seal. However, in this type of construction, problems related to crushed gas diffusion layers, diffusional limitations, and damage from contact with the flow field plate often arises. In addition, it is often difficult to align the gaskets with a membrane exchange assembly (MEA) and the size of the mechanical fasteners typically precludes them from being suitable for use in relatively slim applications.

Moreover, current graphite sub-assemblies are typically machined to include a step to accommodate a silicone-coated fiberglass gasket. The edges of adjacent substrates are vacuum-impregnated with a two-part, liquid, silicone rubber which is subsequently cured to form an edge seal. This construction method suffers from the disadvantage of being tedious, time consuming and expensive. These seals are relatively stiff and require high sealing loads. As a result, this known method of construction typically provides unacceptable sealing performance.

### SUMMARY OF THE INVENTION

According to an embodiment, the present invention pertains to a fuel cell assembly. The fuel cell assembly includes a membrane electrode assembly having a substantially solid polymer electrolyte membrane positioned between opposed catalyst layers. The polymer electrolyte membrane has a dimension that is relatively larger than a comparable dimension of at least one of the catalyst layers, such that the polymer electrolyte membrane has an uncovered portion. The fuel cell assembly also includes a gasket attached to the uncovered portion of the polymer electrolyte membrane. The gasket extends beyond a periphery of the polymer electrolyte membrane and the gasket is formed of a polymer material. In addition, the gasket is configured to substantially prevent leakage of fuel or oxidant between an anode side and a cathode side of the membrane electrode assembly.

According to another embodiment, the invention relates to a method for substantially preventing leakage between fuel and oxidant in a fuel cell. In the method, a first polymeric gasket is attached to a first side of a polymer electrolyte membrane of the fuel cell in a manner to cause the polymeric gasket to extend beyond a periphery of a first end of the polymer electrolyte membrane. A second polymeric gasket is attached to a second side of the polymer electrolyte membrane in a manner to cause the polymeric gasket to extend beyond the periphery of the first end of the polymer electrolyte membrane. In addition, the first polymeric gasket is attached to the second polymeric gasket at a location beyond the periphery of the first end of the polymer electrolyte membrane.

According to a further embodiment, the present invention relates to a fuel cell assembly.

The fuel cell assembly includes: means for supplying fuel to a membrane electrode assembly; means for supplying oxidant to the membrane electrode assembly; means for substantially providing fuel containment between the fuel and oxidant in at least one area beyond a periphery of the membrane electrode assembly, wherein the means for providing fuel containment between the fuel and oxidant comprises a polymeric material; and means for attaching the means for substantially preventing cross-over to the membrane electrode assembly.

According to yet another embodiment, the present invention pertains to a fuel cell assembly. The fuel cell assembly includes a first gasket layer and a second gasket layer attached to each other to form a cavity therebetween. A liquid electrolyte is housed in the cavity formed between the first and second gasket layers, wherein the first and second gasket layers are configured to substantially prevent leakage of the liquid electrolyte from the cavity. In addition, the first and second gasket layers extend beyond a periphery of the liquid electrolyte and the gasket is configured to substantially prevent leakage of fuel or oxidant between an anode side and a cathode side of the liquid electrolyte.

According to a further embodiment, the present invention relates to a method of manufacturing a fuel cell assembly. In the method, a first gasket sheet is supplied and a membrane electrode assembly (MEA) is positioned onto the first gasket sheet. A second gasket sheet is supplied and positioned onto the MEA. Pressure is applied onto the first gasket sheet, the MEA, and the second gasket sheet to adhere the first gasket sheet and the second gasket sheet to the MEA and to adhere the first gasket sheet to the second gasket sheet in one or more locations beyond a periphery of the MEA.

### BRIEF DESCRIPTION OF THE DRAWINGS

Features of the present invention will become apparent to those skilled in the art from the following description with reference to the figures, in which:

FIG. 1A shows a side view of a conventional membrane-electrode assembly;

FIG. 1B illustrates a side view of a fuel cell according to an embodiment of the invention;

FIG. 1C illustrates a side view of the fuel cell depicted in FIG. 1B with current collectors attached, according to an embodiment of the invention;

FIG. 1D illustrates a side view of the fuel cell depicted in FIG. 1C with an additional component attached to the gaskets according to an embodiment of the invention;

FIG. 2 illustrates a top view of a substantially planar fuel cell stack composed of a number of the fuel cells depicted in FIG. 1C, according to an embodiment of the invention;

FIG. 3 illustrates a side view, partially in cross-section, of a substantially vertical fuel cell stack according to an embodiment of the invention;

FIG. 4 is a schematic illustration of a manufacturing process for the fuel cell arrangements illustrated in FIGS. 2 and 3, according to an embodiment of the invention; and

FIG. 5 illustrates a side view of a fuel cell according to another embodiment of the invention.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

According to an embodiment of the invention, a seal or gasket is provided around an edge of a proton exchange membrane, or a polymer electrolyte membrane, (PEM) to substantially prevent leakage between fuel and oxidant. Throughout the present disclosure, the terms “seal” and “gasket” are used interchangeably and may be defined as elements designed to substantially prevent escape of gas or fluids. The gasket may comprise a polymer and may be attached to the PEM with thermoplastic adhesive. The gasket may be positioned along one or more sides of the PEM.

Through the use of gaskets according to embodiments of the invention, leakage and contamination of fuel and oxidant in a PEM fuel cell may be substantially prevented. In addition, this leakage prevention may be achieved with a relatively simple construction that enables multiple fuel cells to be arranged in configurations that have not previously been produced. One result of which is that the costs associated with fabricating the fuel cells according to embodiments of the invention may be relatively low as compared to known fuel cell configurations. Another result is that the fuel cells according to embodiments of the invention may be arranged in various configurations to enable their use in a wide variety of applications. For instance, the fuel cells may be arranged to enable their use in relatively small devices, e.g., portable appliances.

In another regard, through use of these gaskets, improved leakage prevention may be obtained through effective seals created between the gaskets and the PEM. For instance, because the PEM is known to expand due to hydration during operation and to shrink when the PEM is not used for a period of time, by virtue of the materials employed and the manner in which the gaskets are attached to the PEM, a relatively impermeable bond between the gasket and the PEM may be created that may be substantially unaffected by these changes in the PEM.

According to another embodiment, the gaskets may be implemented to seal liquid electrolyte material therebetween. In this regard, the gaskets may operate to effectively prevent leakage of the liquid electrolyte material as well as substantially prevent leakage of fuel and oxidant.

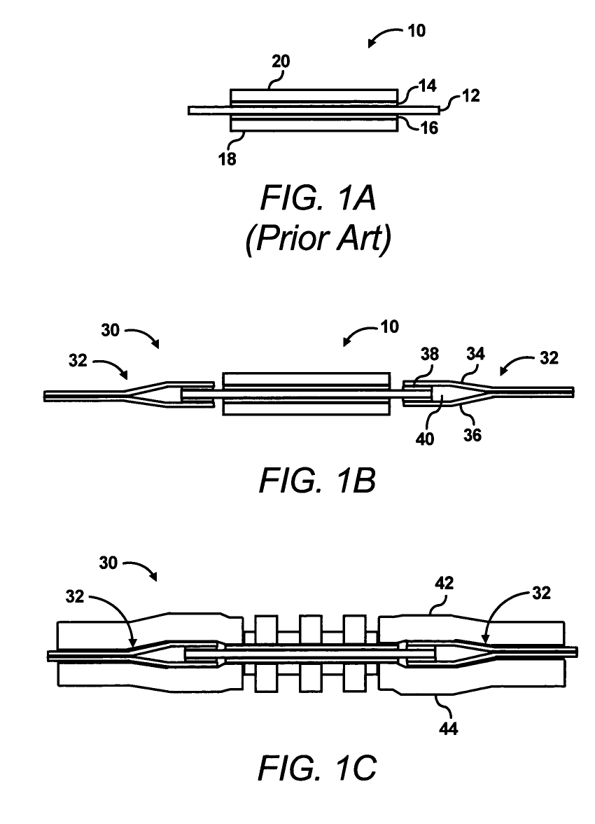

FIGS. 1A-1D, collectively, illustrate a laminating process for creating a seal between fuel and oxidant sides of a fuel cell. With reference first to FIG. 1A, there is shown a side view of a conventional membrane-electrode assembly 10 (MEA). The MEA 10 includes a polymer electrolyte membrane 12, catalyst layers 14 and 16 (e.g., catalyst particles housed in carbon cloth), an anode gas diffusion layer 18, and a cathode gas diffusion layer 20. The side of the MEA 10 containing the anode gas diffusion layer 18 may be considered as the anode side of the MEA 10 and the side containing the cathode gas diffusion layer 20 may be considered as the cathode side of the MEA 10. At the anode side, hydrogen molecules from a fuel, e.g., methanol, give up electrons and form hydrogen ions through the catalyst layer 18. The PEM 12 may comprise a relatively thin plastic sheet that enables hydrogen ions to pass therethrough. More particularly, the PEM 12 generally enables the flow of protons therethrough but substantially prevents electrons from flowing therethrough. The protons travel through the PEM 12 to the cathode side, wherein the hydrogen combines with the oxidant, e.g., oxygen, to produce water. The electrons that are removed from the hydrogen molecules travel through a cathode (not shown) thereby producing electrical current.

FIG. 1B illustrates a side view of a fuel cell 30 according to an embodiment of the invention. The fuel cell 30 includes the MEA 10 described with respect to FIG. 1A. A gasket 32 is illustrated as being attached on two sides of the MEA 10. The gasket 32 is generally positioned on the MEA 10 to substantially prevent leakage along the edges of the MEA 10 between fuel contained on the anode side and the oxidant or air contained on the cathode side. As shown in FIG. 1B, the gaskets 32 are attached to portions of the PEM 12 and extend a substantial distance beyond the edges of the MEA 10.

The gaskets 32 are illustrated as comprising gasket layers 34 and 36. The gasket layers 34 and 36 are also illustrated as being bonded to the PEM 12 with adhesive layers 38. Although the adhesive layers 38 are illustrated as being positioned at the junction between the gasket layers 34 and 36 and the PEM 12, the adhesive layers 38 may extend along substantially the entire lengths of the gasket layers 34 and 36 without departing from the scope of the invention. In this regard, the adhesive layers 38 may operate to bond the gasket layers 34 and 36 together. Alternatively, separate adhesive layers (not shown) may be employed to bond the gasket layers 34 and 36 together.

According to an embodiment of the invention, the gasket layers 34 and 36 may comprise cured film gaskets that are adhered to the PEM 12. The cured film may comprise any reasonably suitable material capable of preventing leakage between the fuel and oxidant. Suitable materials include polymer films, such as, KAPTON, available from Dupont Corporation of Wilmington, Del., ACRYLAM, available from Sheldahl of Northfield, Minn., and the like. The adhesive layers 38 may comprise any reasonably suitable adhesive material capable of providing a relatively strong bond between the gasket layers 34 and 36 and the PEM 12, e.g., thermoplastic adhesive. An example of a suitable adhesive is RFLEX 1000, available from Rogers Corporation of Chandler, Ariz.

According to another embodiment of the invention, the gasket layers 34 and 36 and respective adhesive layers 38 may comprise substantially planar laminates having integrally formed adhesive layers. For instance, the gasket layers 34 and 36 may comprise a polyimide polymer available from Rogers Corporation under the name RFLEX R1100. This laminate has a layer of polyimide and a layer of butyral adhesive.

The combined thickness of the respective gasket layers 34 and 36 and adhesive layers 38 may be approximately equal to the thickness of the catalyst layers 14 and 16. According to an embodiment, the combined thicknesses of the respective gasket layers 34 and 36 and adhesive layers 38 may be slightly larger, e.g., on the order of fractions of mils to a few mils, than the thickness of the catalyst layers 14 and 16. In one regard, employing gaskets 32 having smaller thicknesses may cause components to rise above the gaskets 32 and may be subject to excessive lamination forces.

As further shown in FIG. 1B, a gap 40 is formed between the gasket layers 34 and 36 at a location adjacent the edges of the PEM 12. The gap 40 may be formed to enable space for the expansion of the PEM 12. Alternatively, the gasket layers 34 and 36 may be attached to each other to substantially reduce the size of the gap 40 without departing from the scope of the invention.

FIG. 1C illustrates a side view of the fuel cell 30 depicted in FIG. 1B with current collectors 42 and 44 attached according to an embodiment of the invention. The current collectors 42 and 44 may comprise a cathode current collector 42 and an anode current collector 44. In addition, the current collectors 42 and 44 may be attached to the respective gasket layers 34 and 36 in any reasonably suitable manner. For instance, the current collectors 42 and 44 may be attached with adhesives, welds, mechanical fasteners, etc.

As shown in FIG. 1C, the gaskets 32 provide a base upon which the current collectors 42 and 44 may be attached. In addition, the gaskets 32 are illustrated as extending beyond the outer edges of the current collectors 42 and 44. In this regard, the gaskets 32 generally provide leakage protection between the fuel and oxidant at locations beyond the current collectors 42 and 44. In addition, the gaskets 32 generally function as spacers to support and separate the current collectors 42 and 44. In one regard, the gaskets 32 generally operate to provide electrical insulation between the current collectors 42 and 44. In addition, the gaskets 32 may comprise thicknesses that are approximately the same or slightly larger than the heights of the MEA electrodes. In this respect, the gaskets 32 may be configured to protect the MEA electrodes. For instance, because the current collectors 42 and 44 are clamped onto the MEA 10, the current collectors 42 and 44 may contact the gaskets 32 prior to contacting the MEA electrodes. Thus, the pressure applied onto the current collectors 42 and 44 during their lamination process, may be absorbed by the gaskets 32 instead of being applied to the MEA electrodes. In this regard, the gaskets 32 may operate to protect the MEA electrodes because the risk of crushing or otherwise damaging the MEA electrodes may substantially be eliminated. Moreover, the gaskets 32 may enable the use of greater pressure when attaching the current collectors 42 and 44 to the MEA 10 to thereby create a relatively tighter assembly, since the risk of damaging the MEA electrodes is substantially eliminated.

FIG. 1D illustrates a side view of the fuel cell 30 depicted in FIG. 1C with an additional component 50 attached to the gaskets 32 according to an embodiment of the invention. In FIG. 1D, the additional component 50 comprises a chamber for containing fuel, either in liquid or gaseous form. The chamber 50 may be attached directly to the gaskets 32 in any known reasonably suitable manner. For instance, the chamber 50 may include portions that are heat staked, attached with adhesive, mechanically fastened, and the like. Alternatively, the chamber 50 may be formed substantially integrally with one or more gasket layers 34 and 36 of the gasket 32. In this embodiment, the space in the chamber 50 as well as other structural details of the chamber 50 may be formed, for instance, through laser-ablation. The chamber 50 may thus be formed of the same or similar material as the gaskets 32. For instance, the chamber 50 may comprise a polyimide polymer or other polymer material. It should, however, be understood that the chamber 50 may comprise other suitable materials without departing from the scope of the invention.

The chamber 50 is shown as having a substantially planar bottom wall 52 that extends generally parallel with the fuel cell 30. The bottom wall 52 is also illustrated as extending beyond the outer edges of the fuel cell 30 to thus enable the housing of a relatively large amount of fuel in the chamber. The chamber 50 is also shown as including a vertically extending rear wall 54 configured to space the bottom wall 52 from the fuel cell 30 to thus create the space 56 of the chamber 50. The chamber 50 also includes an inlet portion 58 for receiving fuel into the space 56 of the chamber 50. The inlet portion 58 includes a nozzle-shaped opening 60 and may comprise a substantially circular configuration. Although not shown in FIG. 1D, the chamber 50 may also include side walls configured to substantially enclose the space 56.

What has been illustrated in FIG. 1D is merely one example of many additional components 50 that may be attached to the fuel cell 30 assembly through use of the gaskets 32. Another example of a suitable component 50 is a water transport chamber which may be attached to the gaskets 32 along with the fuel containment chamber 50. In addition, although FIG. 1D is shown as including the fuel containment chamber 50 on the anode side of the fuel cell 30, an oxidant containment chamber (not shown) may also be attached to the gaskets 32 either with or without the fuel containment chamber 50.

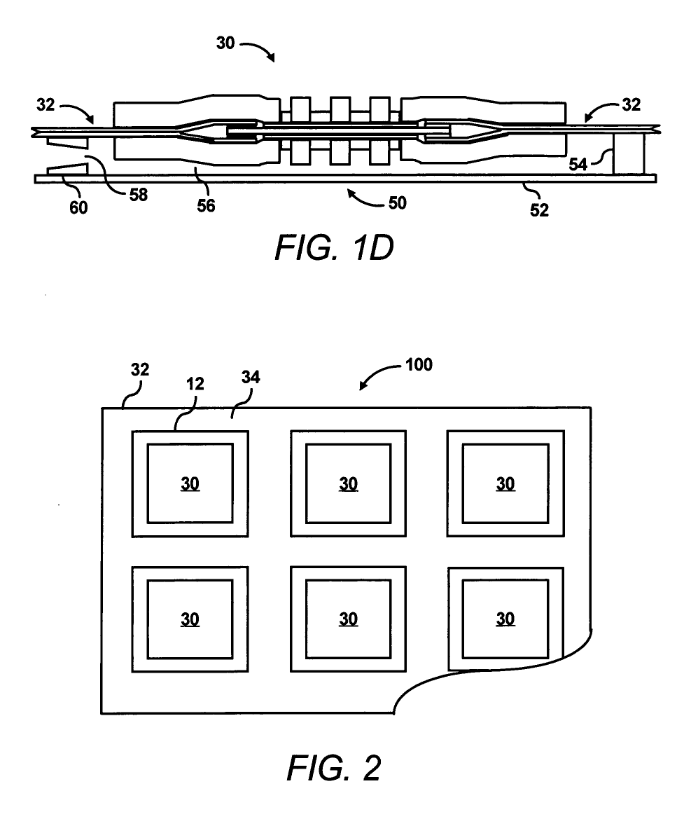

FIG. 2 illustrates a top view of a substantially planar fuel cell stack 100 composed of a number of the fuel cells 30 depicted in FIG. 1C, according to an embodiment of the invention. As shown in FIG. 2, the fuel cells 30 are positioned in a substantially planar arrangement with respect to one another. Although six fuel cells 30 are illustrated in FIG. 2, it should be understood that any number of fuel cells 30 may be placed in the fuel cell stack 100 without departing from the scope of the invention. In addition, although the fuel cells 30 are illustrated as being positioned in two substantially parallel rows, the fuel cells 30 may be positioned in any configuration, e.g., diagonally, regularly or irregularly spaced from each other, randomly, various orientations, etc., without departing from the scope of the invention.

The fuel cells 30 are maintained in their respective positions in the fuel cell stack 100 through the gasket layers 34 and 36 of the gaskets 32. Only the gasket layer 34 is visible in FIG. 2. In cross-section, each of the fuel cells 30 and gasket layers 34 and 36 may have a similar configuration to that shown in FIG. 1C. Therefore, the gasket layers 34 and 36 may be attached to the PEM 12 as described hereinabove.

By virtue of the substantially planar configuration of the fuel cell stack 100, the fuel cell stack 100 may be implemented in very thin applications, e.g., on the order of a few mils. In addition, areas for supplying fuel and oxidant may positioned to provide some or all of the fuel cells 30 with fuel and oxidant. For instance, the fuel containment area(s) and/or the oxidant containment area(s) of the fuel cell stack 100 may comprise the configuration shown in FIG. 1D. In this regard, the delivery of fuel and oxidant to the fuel cells 30 may comprise relatively simple structures as compared with known vertically stacked fuel cell stacks.

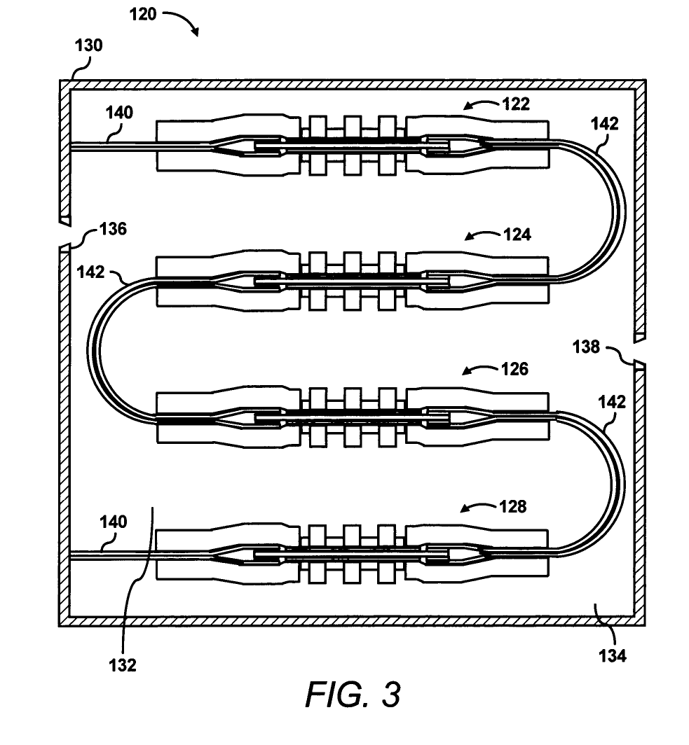

FIG. 3 illustrates a side view, partially in cross-section, of a substantially vertical fuel cell stack 120 according to an embodiment of the invention. As shown in FIG. 3, the fuel cell stack 120 is composed of the fuel cells 122-128 which are similar in construction to the fuel cell 30 illustrated in FIG. 1C. The fuel cell stack 120 is illustrated as having four fuel cells 122-128 for purposes of illustration and not of limitation. Accordingly, the fuel cell stack 120 may include any number of fuel cells 122-128 without departing from the scope of the invention. In addition, other components may be included in the fuel cell stack 120, e.g., water transport plates, etc., and the fuel cells 122-128 may be arranged in a substantially horizontal configuration with respect to each other.

The fuel cell stack 120 includes a housing 130 configured to provide a substantially impregnable barrier for the fuel and oxidant contained in the fuel cell stack 120. Although not shown in FIG. 3, the housing 130 may also include front and rear walls. The housing 130 may also provide structural support for the elements contained in the fuel cell stack 120. In this regard, the housing 130 may comprise any reasonably suitable material capable of operating as a barrier. In addition, the housing may comprise any reasonably suitable material capable of providing structural support to the fuel cell stack 120.

The fuel cell stack 120 generally includes an anode containment chamber 132 and a cathode containment chamber 134. Fuel may be supplied to the anode containment chamber 132 through an anode opening or nozzle 136 and oxidant may be supplied to the cathode containment chamber 134 through a cathode opening or nozzle 138. Undesired leakage between the fuel contained in the anode containment chamber 132 and the oxidant contained in the cathode containment chamber 134 may substantially be prevented through implementation of the fuel cell configuration consistent with embodiments of the invention. More particularly, as shown in FIG. 3, a plurality of gaskets 140 and 142 are positioned to separate the anode containment chamber 132 from the cathode containment chamber 134. The gaskets 140 and 142 may comprise the materials and functionality of the gaskets 30 described hereinabove.

The gaskets 140 are illustrated as being attached to an inner wall of the housing 130. In this regard, the gaskets 140 operate to substantially prevent leakage at the periphery of the MEA from the fuel cells 122 and 128 and the junction with the housing 130. The gaskets 142 are illustrated as being attached between adjacent fuel cells 122-128. The gaskets 142 are also illustrated as having a substantially curved configuration to substantially provide leakage prevention between the adjacent fuel cells 122-128. In this regard, the gaskets 142 may comprise a relatively flexible material capable of bending into a curved shape. Alternatively, the gaskets 142 may comprise a relatively stiff material that may be preformed into the curved shape illustrated in FIG. 3. As a yet further alternative, the gaskets 142 may comprise relatively straight sections that are attached between adjacent fuel cells 122-128.

As can be appreciated from the illustration in FIG. 3, the fuel cells 122-128 are arranged such that the anode sides of the fuel cells 122-128 face the anode containment chamber 132 and the cathode sides face the cathode containment chamber 132. In this regard, the fuel cells 122 and 126 face one direction and the fuel cells 124 and 128 face the opposite direction.

According to an embodiment of the invention, multiple fuel cells may be positioned in the locations of the fuel cells 122-128. For instance, each level of the fuel cell stack 120, e.g., the locations of the fuel cells 122-128, may comprise the fuel cell stack arrangement illustrated in FIG. 2. In this regard, the fuel cell stack 120 may comprise a relatively large array of fuel cells. In addition, the delivery system of the fuel and oxidant to the fuel cells may be relatively simple as compared with known delivery systems since a single fuel source, for instance, may be employed to supply multiple fuel cells with fuel instead of requiring individual delivery systems for individual fuel cells.

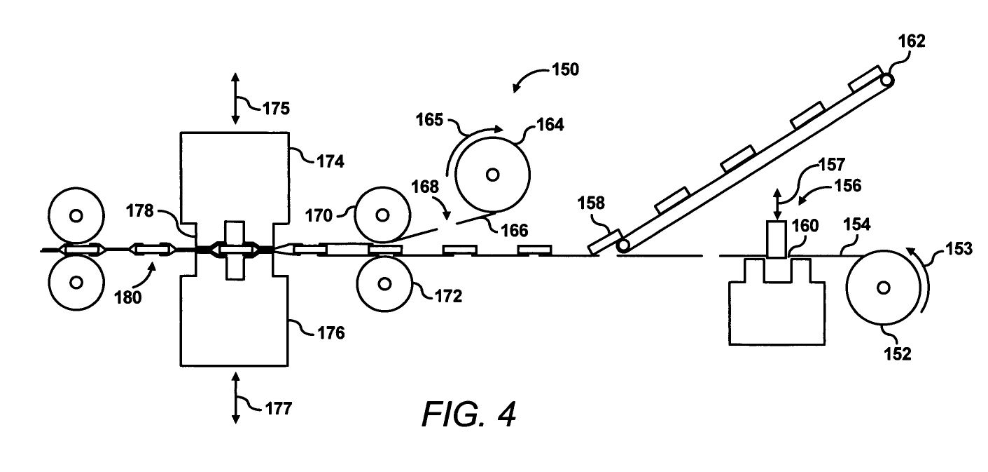

FIG. 4 is a schematic illustration of a manufacturing process 150 for the fuel cell arrangements 100 and 120 illustrated in FIGS. 2 and 3, according to an embodiment of the invention. FIG. 4 represents a generalized illustration and other components may be added or existing components may be removed or modified without departing from the scope of the invention. For example, the manufacturing process 150 may include any additional devices for applying, for instance, the current collectors 42 and 44, or other components of the fuel cell assemblies 100 and 120. In addition, the manufacturing process 150 may include devices for applying adhesive or elements to the fuel cells or gaskets. Thus, it should be understood that the manufacturing process 150 depicted in FIG. 4 is for purposes of illustration and simplicity of description.

The manufacturing process 150 includes a first reel 152 of a first gasket sheet 154 and is configured to rotate in the direction indicated by the arrow 153. The first gasket sheet 154 may comprise the same or similar construction and materials as described hereinabove with respect to the gasket layers 34 and 36. The first gasket sheet 154 is fed passed a hole punching device 156. The hole punching device 156 generally operates to punch holes in the first gasket sheet 154 along various sections of the first gasket sheet 154 by moving in the directions indicated by the arrow 157. In addition, the hole punching device 156 is generally configured to punch holes in the first gasket sheet 154 at locations designed to receive MEA's 158. Moreover, the hole punching device 156 is configured to create openings 160 in the first gasket sheet 154 while leaving material along the sides of the openings 160. Therefore, the illustration of the first gasket sheet 154 is generally a cross-sectional view thereof to depict the locations of the openings 160.

As the first gasket sheet 154 is fed along, an MEA 158 is placed around the locations of the openings 160. The MEA's 158 are illustrated as being supplied from a conveyor belt 162. The conveyor belt 162 is configured to supply and position the MEA's 158 along the openings 160 to therefore position the MEA's 158 along their appropriate positions. Although not shown in FIG. 4, additional devices, e.g., scrapers and other suitable devices for aligning the MEA's 158 on the first gasket sheet 154, may be provided in the manufacturing process 150 to assist in the removal from the conveyor belt 162 and the placement of the MEA's 158. In addition, although the manufacturing process 150 is illustrated as containing a hole punching device 156 to create the openings 160 along the first gasket sheet 154, the first reel 152 may be supplied with a first gasket sheet 154 having openings 160 prefabricated therein. Therefore, the hole punching device 156 may be removed without departing from the scope of the invention.

According to an embodiment of the invention, the first gasket sheet 154 may include an adhesive layer as described hereinabove. Alternatively, an adhesive layer may be applied to the first gasket sheet 154 prior to application of the MEA's 158 thereon. In this regard, the adhesive layer may be supplied from a separate reel, for instance, and may be configured to be supplied in a manner similar to the supply of the first gasket sheet 154.

The manufacturing process 150 is also illustrated as including a second reel 164 of a second gasket sheet 166 and that is generally configured to rotate in the direction indicated by the arrow 165. As shown in FIG. 4, the second reel 164 is configured to supply the second gasket sheet 166 for application onto the MEA's 158. The second gasket sheet 166 is illustrated as comprising openings 168 prefabricated into the second gasket sheet 166. The openings 168 may be spaced apart from one another to generally coincide with the locations of the MEA's 158 positioned on the first gasket layer 154.

However, as described hereinabove with respect to the first gasket sheet 154, a hole punching device (not shown) may be employed to create the openings 168. In addition, the second gasket sheet 166 may include an adhesive layer as described hereinabove or an adhesive layer may be applied onto the surface of the second gasket sheet 166 configured to contact the MEA's 158.

In any event, the first gasket sheet 154, the second gasket sheet 166, and the MEA's 158 are passed through a par of rollers 170 and 172. The rollers 170 and 172 generally operate to apply pressure onto and to guide the first gasket sheet 154, the second gasket sheet 166, and the MEA's 158. The first gasket sheet 154, the second gasket sheet 166, and the MEA's 158, after passing the rollers 170 and 172, are positioned between a pair of pressure applying devices 174 and 176. The pressure applying devices 174 and 176 are configured to move in the respective directions illustrated by the arrows 175 and 177. As shown in FIG. 4, the pressure applying devices 174 and 176 generally comprise configurations to enable pressure to be applied on the edges of the MEA's 158 and beyond the periphery of the MEA's 158. In this regard, the pressure applying devices 174 and 176 generally include contacting surfaces 178 having various heights.

Although not shown in FIG. 4, the pressure applying devices 174 and 176 may include contacting surfaces 178 around each side of the MEA 158. In this regard, the pressure applying devices 174 and 176 may apply pressure to and around each side of the MEA 158. In addition, the pressure applying devices 174 and 176 may include means for applying heat to the first gasket sheet 158 and the second gasket sheet 166 during application of pressure. In this regard, the heat supplied through the contacting surfaces 178 may activate thermoplastic adhesives contained between the first gasket sheet 158 and the second gasket sheet 166 as well as between the gasket sheets 158 and 166 and the MEA 158.

In operation, the pressure applying devices 174 and 176 move in directions generally away from each other to enable the first gasket sheet 154, the second gasket sheet 166, and the MEA 158 to pass therebetween. Once these components are substantially correctly aligned between the pressure applying devices 174 and 176, the pressure applying devices 174 and 176 move in directions generally toward each other. As the pressure applying devices 174 and 176 move toward each other, the contacting surfaces 178 apply pressure to the first gasket sheet 158 and the second gasket sheet 166 to thereby cause the first gasket sheet 158 and the second gasket sheet 166 to adhere to the MEA 158 and to each other. The resulting construction, e.g., the gasket and MEA assembly 180, may appear similar to the fuel cell illustrated in FIG. 1B, for instance.

After the pressure applying devices 174 and 176 have applied pressure and, in certain embodiments, heat, to the gasket and MEA assembly 180, the pressure applying devices 174 and 176 may move in directions generally away from each other. Once the pressure applying devices 174 and 176 have moved a sufficient distance away from each other, the gasket and MEA assembly 180 is caused to continue to move beyond the pressure applying devices 174 and 176. A pair of rollers 182 and 184 are positioned downstream of the pressure applying devices 174 and 176 to guide the gasket and MEA assembly 180.

After going passed the rollers 182 and 184, the gasket and MEA assembly 180 may receive additional components, for instance, the fuel chamber 50 described with respect to FIG. 1C. In addition, the gasket and MEA assembly 180 may be rolled onto, for instance, another reel for storage and transport. Moreover, the gasket and MEA assembly 180 may be cut into sections having any number of gasket and MEA assemblies 180 to form, for instance, the fuel cell assembly 100 illustrated in FIG. 2. As a yet further example, the cut sections may be bent in the manner illustrated in FIG. 3 to create part of the fuel cell assembly 120.

According to an embodiment of the invention, the manufacturing process 150 may include additional manufacturing components designed to simultaneously create an array gasket and MEA assemblies 180. For instance, the first gasket sheet 154 and the second gasket sheet 166 may extend into the sheet of FIG. 4 to include a number of respective openings 160 and 168 extending into the sheet. In this regard, a substantially planar sheet of gasket and MEA assemblies 180 may be fabricated.

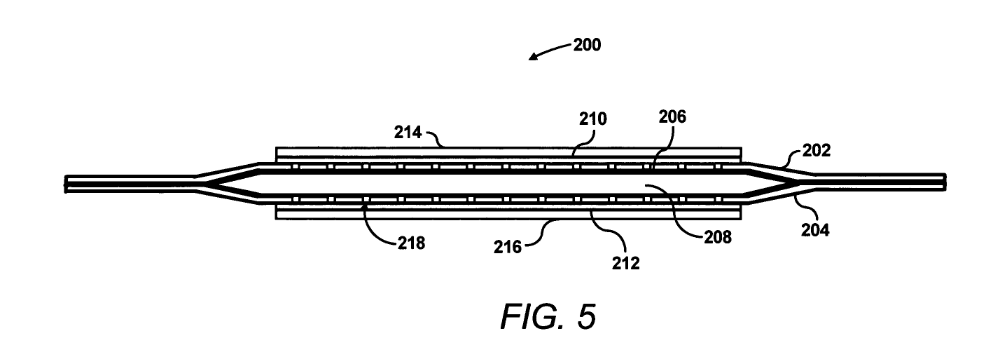

FIG. 5 illustrates a side view of a fuel cell 200 according to another embodiment of the invention. The fuel cell 200 includes a pair of gasket layers 202 and 204 that extend substantially the entire length of the fuel cell 200. The gasket layers 202 and 204 may comprise the materials described hereinabove with respect to FIG. 1B. In addition, the gasket layers 202 and 204 may be adhered to each other as described hereinabove.

The gasket layers 202 and 204 are attached to each other in a manner to provide a cavity 206 along a portion thereof. The cavity 206 is generally configured to house an electrolyte 208 in liquid form. In addition, catalyst layers 210 and 212 (e.g., catalyst particles housed in carbon cloth), an anode gas diffusion layer 214, and a cathode gas diffusion layer 216 are provided on the sides of the gasket layers 202 and 204 opposite the cavity 206.

The side of the fuel cell 200 containing the anode gas diffusion layer 214 may be considered as the anode side of the fuel cell 200 and the side containing the cathode gas diffusion layer 216 may be considered as the cathode side of the fuel cell 200. At the anode side, hydrogen molecules from a fuel, e.g., methanol, give up electrons and form hydrogen ions through the catalyst layer 210. The electrolyte 208 is generally selected to enable hydrogen ions to pass therethrough. More particularly, the electrolyte 208 generally enables the flow of protons therethrough but substantially prevents electrons from flowing therethrough. The protons travel through the electrolyte 208 to the cathode side, wherein the hydrogen combines with the oxidant, e.g., oxygen, to produce water. The electrons that are removed from the hydrogen molecules travel through a cathode (not shown) thereby producing electrical current.

According to the embodiment shown in FIG. 5, the gasket layers 202 and 204 comprise porous structures having holes 218. The holes 218 in the gasket layer 202 generally enable the protons from the fuel to travel through the gasket layer 202. In addition, the holes 218 in the gasket layer 204 generally enable the protons to flow out of the electrolyte 208 and into the cathode side. The holes 218 may include a hydrophobic coating to substantially prevent the liquid electrolyte 208 from escaping the cavity 206.

By virtue of certain embodiments of the present invention, unwanted mixing between fuel and oxidant in a fuel cell may substantially be reduced or eliminated through use of a relatively simple gasket construction. In addition, the gasket construction of various embodiments of the invention generally enables fuel cell stack configurations that have heretofore been impractical or impossible. Moreover, the costs associated with producing the fuel cell stacks consistent with embodiments of the invention may be substantially low compared with known fuel stack fabrication techniques due to the relatively simple construction of the gaskets and because of the relatively simple manner in which the gaskets may be attached to the fuel cells. In one respect, embodiments of the present invention do not suffer from those disadvantages associated with the relatively complicated fabrication techniques associated with known fuel cell production.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

1. A fuel cell assembly comprising:
a membrane electrode assembly including a substantially solid polymer electrolyte membrane positioned between opposed catalyst layers, the polymer electrolyte membrane having a dimension that is larger than a comparable dimension of at least one of the catalyst layers, such that the polymer electrolyte membrane has an uncovered portion; and
a gasket attached to the uncovered portion of the polymer electrolyte membrane, wherein the gasket extends beyond a periphery of the polymer electrolyte membrane and wherein the gasket is formed of a polymer material, said gasket being configured to substantially prevent leakage of fuel or oxidant between an anode side and a cathode side of the membrane electrode assembly.

2. The fuel cell assembly according to claim 1, further comprising:
a thermoplastic adhesive, wherein the gasket is attached to the uncovered portion of the polymer electrolyte membrane with the thermoplastic adhesive.

3. The fuel cell assembly according to claim 2, wherein the gasket and thermoplastic adhesive are integrally formed.

4. The fuel cell assembly according to claim 1, wherein the gasket has a height and the catalyst layers have respective heights, and wherein the height of the gasket is substantially equal to or greater than the respective heights of the catalyst layers.

5. The fuel cell assembly according to claim 1, further comprising:
an anode collector plate; and
a cathode collector plate,
wherein the anode collector plate and the cathode collector plate are attached to opposide surfaces of the gasket.

6. The fuel cell assembly according to claim 1, wherein the dimension of the polymer electrolyte membrane is larger than comparable dimensions of the opposed catalyst layers, such that the polymer electrolyte membrane has uncovered portions on both the anode side and the cathode side, and wherein a first gasket is attached to the uncovered portion of the anode side and a second gasket is attached to the uncovered portion of the cathode side.

7. The fuel cell assembly according to claim 6, wherein the first gasket and the second gasket are attached to each other beyond the periphery of the polymer electrolyte membrane.

8. The fuel cell assembly according to claim 1, wherein the polymer electrolyte membrane contains a plurality of uncovered portions around at least two ends of the polymer electrolyte membrane and wherein gaskets are attached to the plurality of uncovered portions on the at least two ends of the polymer electrolyte membrane.

9. The fuel cell assembly according to claim 8, wherein a first gasket and a second gasket are attached to each of the two ends of the polymer electrolyte membrane, and wherein the first gasket and the second gasket are attached to each other beyond the periphery of the polymer electrolyte membrane.

10. The fuel cell assembly according to claim 1, further comprising:
a containment chamber, wherein the containment chamber is at least one of attached to the gasket or integrally formed with the gasket.

11. The fuel cell assembly according to claim 1, further comprising:
a plurality of membrane electrode assemblies positioned in a substantially planar arrangement with respect to each other and wherein the gasket is attached to polymer electrolyte membranes of the plurality of membrane electrode assemblies.

12. The fuel cell assembly according to claim 1, further comprising:
a plurality of membrane electrode assemblies positioned in a stacked arrangement with respect to each other and wherein the gasket is attached to the polymer electrolyte membranes of adjacent ones of the membrane electrode assemblies.

13. The fuel cell assembly according to claim 12, further comprising:
a housing containing the plurality of membrane electrode assemblies; and
one or more gaskets being attached to the housing.

14. The fuel cell assembly according to claim 13, wherein the plurality of membrane electrode assemblies and the gaskets are configured to separate the housing into a fuel containment chamber and an oxidant containment chamber, and wherein the housing contains a fuel inlet and an oxidant inlet.

15. The fuel cell assembly according to claim 14, wherein the anode sides of the plurality of membrane electrode assemblies face the fuel containment chamber and the cathode sides of the plurality of membrane electrode assemblies face the oxidant containment chamber.

16. A method for substantially preventing leakage between fuel and oxidant in a fuel cell, said method comprising:
attaching a first polymeric gasket to a first side of a polymer electrolyte membrane of the fuel cell in a manner to cause the polymeric gasket to extend beyond a periphery of a first end of the polymer electrolyte membrane;
attaching a second polymeric gasket to a second side of the polymer electrolyte membrane in a manner to cause the polymeric gasket to extend beyond the periphery of the first end of the polymer electrolyte membrane; and
attaching the first polymeric gasket to the second polymeric gasket at a location beyond the periphery of the first end of the polymer electrolyte membrane.

17. The method according to claim 16, wherein the steps of attaching the first polymeric gasket and the second polymeric gasket to the polymer electrolyte membrane further comprises adhering the first polymeric gasket and the second polymeric gasket to the polymer electrolyte membrane with a thermoplastic adhesive.

18. The method according to claim 16, wherein the step of attaching the first polymeric gasket to the second polymeric gasket further comprises adhering the first polymeric gasket to the second polymeric gasket with a thermoplastic adhesive.

19. The method according to claim 16, further comprising:
attaching a first current collector to a surface of the first polymeric gasket; and
attaching a second current collector to a surface of the second polymeric gasket, wherein the first polymeric gasket and the second polymer gasket functions as a spacer between the first current collector and the second current collector.

20. The method according to claim 16, further comprising:
attaching an additional fuel cell component to at least one of the first polymeric gasket and the second polymeric gasket.

21. The method according to claim 16, further comprising:
forming an additional fuel cell component from at least one of the first polymeric gasket and the second polymeric gasket.

22. The method according to claim 16, further comprising:
positioning a plurality of fuel cells in a substantially planar arrangement with respect to one another;
attaching the first polymeric gasket to the first sides of the polymer electrolyte membranes of the fuel cells; and
attaching the second polymeric gasket to the second sides of the polymer electrolyte membranes of the fuel cells, wherein the first polymeric gasket and the second polymeric gasket operate to substantially prevent leakage between anode sides and cathode sides of the plurality of fuel cells.

23. The method according to claim 22, further comprising:
attaching the first polymeric gasket to the second polymeric gasket in locations between the plurality of fuel cells.

24. The method according to claim 16, further comprising:
positioning a plurality of fuel cells in a substantially stacked arrangement with respect to each other;
attaching the first polymeric gasket to the first sides of adjacent fuel cells; and
attaching the second polymeric gasket to the second sides of adjacent fuel cells.

25. The method according to claim 24, further comprising:
providing a housing for containing the plurality of fuel cells;
separating the housing into a fuel containment chamber and an oxidant containment chamber with the plurality of fuel cells, the first polymeric gasket and the second polymeric gasket; and
wherein the first sides of the fuel cells face one of the fuel containment chamber and the oxidant containment chamber and the second sides of the fuel cells face the other of the fuel containment chamber and the oxidant containment chamber.

26. A fuel cell assembly comprising:
means for supplying fuel to a membrane electrode assembly;
means for supplying oxidant to the membrane electrode assembly;
means for providing fuel containment between the fuel and oxidant in at least one area beyond a periphery of the membrane electrode assembly, wherein the means for providing fuel containment between the fuel and oxidant comprises a polymeric material; and
means for attaching the means for substantially preventing leakage to the membrane electrode assembly.

27. The fuel cell assembly according to claim 26, wherein the means for providing fuel containment comprises means for supporting a plurality of membrane electrode assemblies in a substantially planar arrangement with respect to each other.

28. The fuel cell assembly according to claim 26, wherein the means for providing fuel containment comprises means for supporting a plurality of membrane electrode assemblies in a substantially stacked arrangement with respect to each other.

29. A fuel cell assembly comprising:
a first gasket layer and a second gasket layer attached to each other to form a cavity therebetween;
a liquid electrolyte housed in the cavity formed between the first and second gasket layers, wherein the first and second gasket layers are configured to substantially prevent leakage of the liquid electrolyte from the cavity; and
wherein the first and second gasket layers extend beyond a periphery of the liquid electrolyte, said gasket being configured to substantially prevent leakage of fuel or oxidant between an anode side and a cathode side of the liquid electrolyte.

30. The fuel cell assembly according to claim 29, further comprising:
a first catalyst layer attached to a surface of the first gasket layer opposite the cavity; and
a second catalyst layer attached to a surface of the second gasket layer opposite the cavity.

31. The fuel cell assembly according to claim 30, further comprising:
an anode gas diffusion layer attached to a surface of the first catalyst layer; and
a cathode gas diffusion layer attached to a surface of the second catalyst layer.

32. The fuel cell assembly according to claim 29, wherein one or both of the first gasket layer and the second gasket layer comprise holes to enable a flow of protons therethrough.

33. The fuel cell assembly according to claim 32, further comprising:
a hydrophobic coating applied to the holes.

34. A method of manufacturing a fuel cell assembly, said method comprising:
supplying a first gasket sheet;
positioning a membrane electrode assembly (MEA) onto the first gasket sheet;
supplying a second gasket sheet;
positioning the second gasket sheet onto the MEA; and
applying pressure onto the first gasket sheet, the MEA, and the second gasket sheet to adhere the first gasket sheet and the second gasket sheet to the MEA and to adhere the first gasket sheet to the second gasket sheet in one or more locations beyond a periphery of the MEA.

35. The method according to claim 34, wherein one or both of the steps of supplying a first gasket sheet and supplying a second gasket sheet comprises supplying a gasket sheet having a plurality of prefabricated openings.

36. The method according to claim 35, wherein the step of positioned the MEA onto the first gasket sheet comprises positioning the MEA onto a location on the first gasket sheet substantially over the hole.

37. The method according to claim 34, further comprising:
prior to the step of positioning the MEA onto the first gasket sheet, punching a hole into the first gasket sheet, wherein the hole has at least one dimension that is smaller than a corresponding dimension on the MEA.

38. The method according to claim 37, wherein the step ofpositioningthe MEA onto the first gasket sheet comprises positioning the MEA onto a location on the first gasket sheet substantially over the hole.

39. The method according to claim 34, further comprising:
prior to the step of positioning the second gasket sheet onto the MEA, punching a hole into the second gasket sheet, wherein the hole has at least one dimension that is smaller than a corresponding dimension on the MEA.

40. The method according to claim 39, wherein the step of positioning the second gasket sheet onto the MEA comprises positioning the second gasket sheet onto the MEA such that the hole is substantially over the MEA.

41. The method according to claim 34, wherein the steps of supplying the first gasket sheet and supplying the second gasket sheet comprise supplying a first gasket sheet having an adhesive layer and supplying a second gasket sheet having an adhesive layer.

42. The method according to claim 34, further comprising:
prior to the step of positioning the MEA onto the first gasket sheet, applying an adhesive layer to the first gasket sheet; and
prior to the step of positioning the second gasket sheet onto the MEA, applying an adhesive layer to the second gasket sheet.

43. The method according to claim 34, further comprising:
cutting the adhered first gasket sheet, MEA, and second gasket sheet into one or more sections to form one or more substantially planar fuel cell arrangements.

44. The method according to claim 43, further comprising:
bending one or more of the cut sections to form one or more substantially stacked fuel cell arrangements.
